(19) United States
(12) Patent Application Publication
(10) Pub. No.: US 2025/0300507 A1
(43) Pub. Date: Sep. 25, 2025

(54) SCALABLE TORQUE ELECTRIC MOTOR AND METHOD FOR DESIGNING THE SAME

(71) Applicant: HL MANDO CORPORATION, Gyeonggi-do (KR)

(72) Inventors: Mohammad ISLAM, Bay City, MI (US); Md Sariful ISLAM, Bay City, MI (US)

(21) Appl. No.: 18/978,608

(22) Filed: Dec. 12, 2024

Related U.S. Application Data
(60) Provisional application No. 63/567,919, filed on Mar. 20, 2024.

(51) Int. Cl. H02K 1/279; B60T 13/74; B62D 5/04; F16D 65/16; F16D 121/24; H02K 21/22; H02K 29/03

(52) U.S. Cl. CPC H02K 1/279; B62D 5/0403; H02K 21/22; B60T 13/74; F16D 65/16; F16D 2121/24; H02K 29/03; H02K 2201/06

(57) ABSTRACT

A motor includes: a stator assembly; and a rotor assembly configured to be rotatable relative to the stator assembly. The rotor assembly includes a rotor body that includes: a first group of magnet pockets including three first magnet pockets; and a second group of magnet pockets including two second magnet pockets, the second group of magnet pockets being positioned closer toward an inner surface of the rotor body than the first group of magnet pockets.

This application claims priority to U.S. Provisional Application No. 63/567,919 filed Mar. 20, 2024, the entirety of which is incorporated herein by reference.

### BACKGROUND

Various embodiments of the present disclosure relate in general to an electric motor, and more particularly, to a structure and components of stator and rotor assemblies of an electric motor.

A motor is a well-known electrical machine that converts electrical energy into mechanical energy using magnetic field linkage. Motors are also designed to meet different torque requirements of different drive modes (e.g., forward wheel drive (FWD), rear wheel drive (RWD), and all wheel drive (AWD)) of a vehicle. In order to keep a same motor design for all three drive modes while also advantageously reducing development time of the motor, a motor having a variable torque output will be required.

In certain types of motors (e.g., propulsion, electric power steering (EPS), brake motors, or the like), the torque output of a motor can be varied by tuning the turn number and length while the lamination of the motor is kept the same. However, other types of motors (e.g., in-wheel motors, corner module motors, motors with certain types of winding configurations, or the like), have no space to grow in an axial direction to achieve such variable torque output.

As a result, if an application (e.g., any of the three drive modes) requires one of these motors (e.g., in-wheel motors, corner module motors, motors with certain types of winding configurations, or the like) to produce higher or less torque, an existing design of such motors will need to be significantly changed to accommodate such requirements, which disadvantageously increases cost and time requirements for adapting these motor's existing design to a user's desired use of these motors.

Additionally, motor length should be minimized to the extent possible. Busbars and other components installed onto the motors usually add additional length that later becomes problematic during packaging and/or installation of the motors. These components that attribute additional length to a motor should advantageously be configured (i.e., installed) in way that does not add more to the length of the motor.

It is with respect to these and other general considerations that the following embodiments have been described. Also, although relatively specific problems have been discussed, it should be understood that the embodiments should not be limited to solving the specific problems identified in the background.

### SUMMARY

The features and advantages of the present disclosure will be more readily understood and apparent from the following detailed description, which should be read in conjunction with the accompanying drawings, and from the claims which are appended to the end of the detailed description.

According to various embodiment of the present disclosure, a motor may comprise: a stator assembly; and a rotor assembly configured to be rotatable relative to the stator assembly. The rotor assembly comprises a rotor body that comprises: a first group of magnet pockets comprising three first magnet pockets; and a second group of magnet pockets comprising two second magnet pockets, the second group of magnet pockets being positioned closer toward an inner surface of the rotor body than the first group of magnet pockets.

The rotor assembly surrounds the stator assembly.

The rotor assembly further comprises a skew hole and an overmold hole.

The three first magnet pockets form a U-shape with a bottom of the U-shape being flat and made up of one of the three first magnet pockets and two legs of the U-shape being respectively made up of a remaining two of the three first magnet pockets.

The two second magnet pockets form a V-shape, and the two second magnets are position within the U-shape formed by the three first magnet pockets.

A single pole of the rotor comprises one set of the three first magnet pockets and one set of the two second magnet pockets.

The rotor assembly further comprises magnets installed within at least one of the first group of magnet pockets or the second group of magnet pockets in one or more magnet combinations, each of the one or more magnet combinations affecting a torque output of the motor.

The one or more magnet combinations comprises combinations made up of a first set of magnets, a second set of magnets, and a third set of magnets, the first set of magnets occupying the two legs of the U-shape formed by the three first magnet pockets, the second set of magnets occupying the two second magnet pockets forming the V-shape, and the third set of magnets occupying the one of the three first magnet pockets making up the bottom of the U-shape.

The overmold hole is connected to at least one of the first and/or second groups of magnet pockets.

The overmold hole is a hole in which molding material flows for backfilling at least one of the three first magnet pockets or at least one of the two second magnet pockets during a molding process of the rotor assembly.

The motor comprises a plurality of the first group of magnet pockets, the skew hole is positioned between at least two of the plurality of the first group of magnet pockets and shifted by θ_{skew}/2 from a centerline of the motor, and an area between at least two of the plurality of the first group of magnet comprises only one of either the skew hole or the overmold hole.

The motor is an in-wheel motor for an electric vehicle.

According to some embodiments of the present disclosure, a vehicle may comprise: one or more road wheels configured to cause the vehicle to move; a steering wheel configured to generate an input for controlling the one or more road wheels; a brake assembly configured to operate a vehicle brake associated with the one or more road wheels; and one or more motors operatively connected to one or more of the one or more road wheels, the steering wheel and the brake assembly. At least one of the motors comprises: a stator assembly; and a rotor assembly configured to be rotatable relative to the stator assembly. The rotor assembly comprises a rotor body that comprises: a first group of magnet pockets comprising three first magnet pockets; and a second group of magnet pockets comprising two second magnet pockets, the second group of magnet pockets being positioned closer toward an inner surface of the rotor body than the first group of magnet pockets.

This Summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Various embodiments in accordance with the present disclosure will be described with reference to the drawings, in which:

FIG. 1 shows a motor according to an exemplary embodiment of the present disclosure.

FIGS. 2A-2D show a horizontal cross-sectional view of the motor of FIG. 1 according to an exemplary embodiment of the present disclosure.

FIG. 3A shows a conceptual view of schematically illustrating a hairpin winding segment according to an embodiment of the present disclosure.

FIG. 3B shows a conceptual view of schematically illustrating the hairpin winding segment of FIG. 3A being inserted into a stator core according to an embodiment of the present disclosure.

FIGS. 4A-4C show perspective views of a stator assembly according to an embodiment of the present disclosure.

FIG. 5 is a schematic view of a vehicle including a steering system and a brake assembly according to an exemplary embodiment of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF EMBODIMENTS

In the following detailed description, reference is made to the accompanying drawings which form a part of the present disclosure, and in which are shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the spirit and scope of the invention. The following detailed description is therefore not to be taken in a limiting sense, and the scope of the invention is defined only by the appended claims and equivalents thereof. Like numbers in the figures refer to like components, which should be apparent from the context of use.

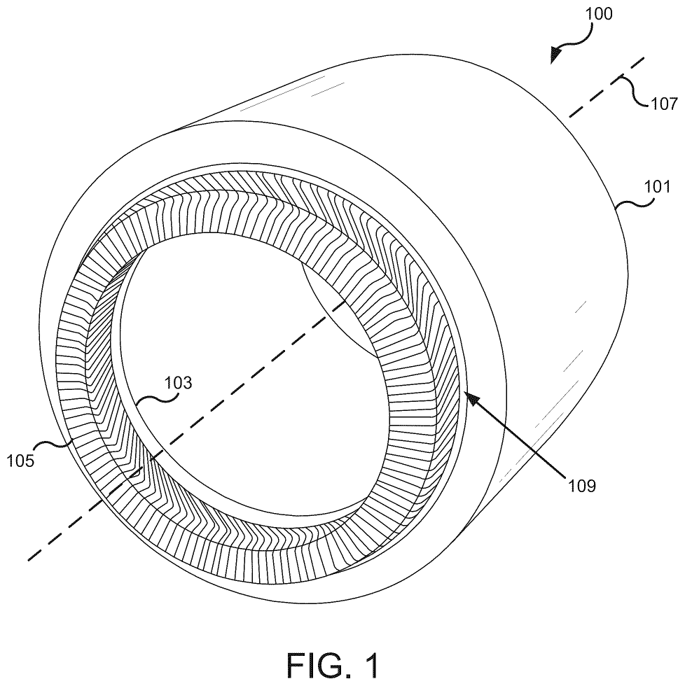

FIG. 1 shows a motor 100 in accordance with to an exemplary embodiment of the present disclosure.

As shown in FIG. 1, the motor 100 may include a rotor assembly 101 and a stator assembly 103 having a winding assembly 105. The rotor assembly 101 and the stator assembly 103 may each be disposed about and extend along a central axis 107. The rotor assembly 101 may be disposed concentric with the stator assembly 103 such that rotor assembly 101 is rotatable relative to the stator assembly 103. Said another way, the rotor assembly 101 rotates about the central axis 107 along an outer circumference (i.e., surface) of the stator assembly 103.

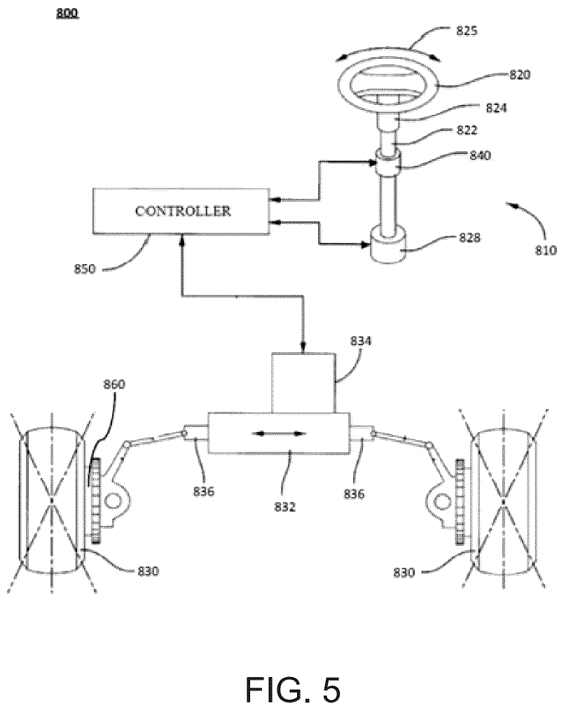

The rotor assembly 101 may be configured to surround the stator assembly 103. In one exemplary embodiment, the motor 100 may be an in-wheel motor for an electric vehicle (see, e.g., vehicle 800 in FIG. 5) having at least four road wheels. The motor 100 may be an in-wheel motor that is installed directly onto a wheel hub (not shown) of any one of the road wheels of the electric vehicle. In another exemplary embodiment, the motor may be any other type of electrical motor with a design where the rotor assembly 101 surrounds the stator assembly 103.

A gap 109 (e.g., an air gap or the like) may be included between an inner surface of the rotor assembly 101 and an outer surface of the stator assembly 103. The gap 109 may be of any size suitable for an in-wheel motor design, and is included to prevent friction (e.g., as a result of direct physical contact) between the inner surface of the rotor assembly 103 and the outer surface of the stator assembly 103 as the rotor assembly 101 rotates around the stator assembly 103.

In embodiments, the motor 100 may not include a rotor shaft but may instead include a stator shaft, or other type of mechanical structure, (not shown) that mechanically fixes the stator assembly 103 and or the rotor assembly 101 to the wheel hub of a road wheel and/or to a vehicle axel of the vehicle.

The stator assembly 103 may include a winding assembly 105 made up of a plurality of electrical conductors. The winding assembly 105, when excited, may generate an electromagnetic flux that causes the rotor assembly 101 to rotate about the stator assembly 103.

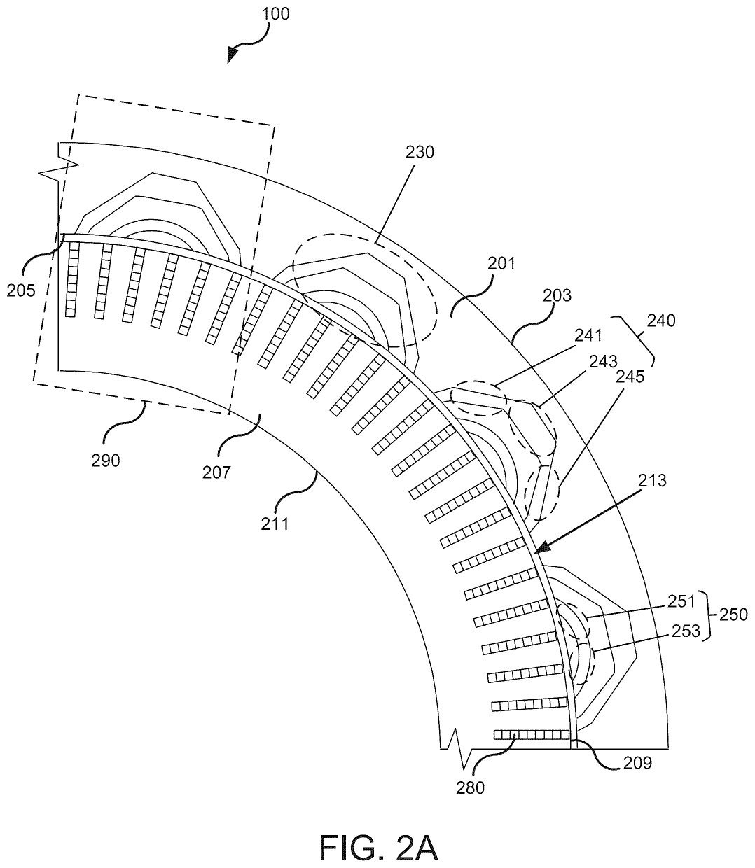

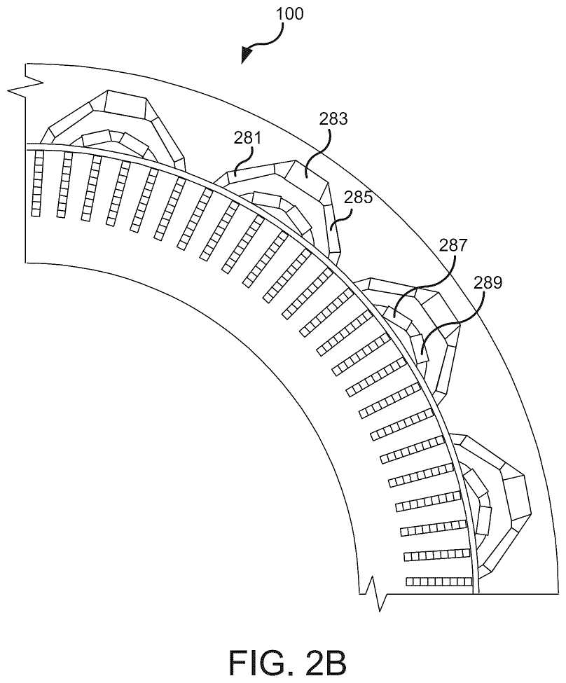

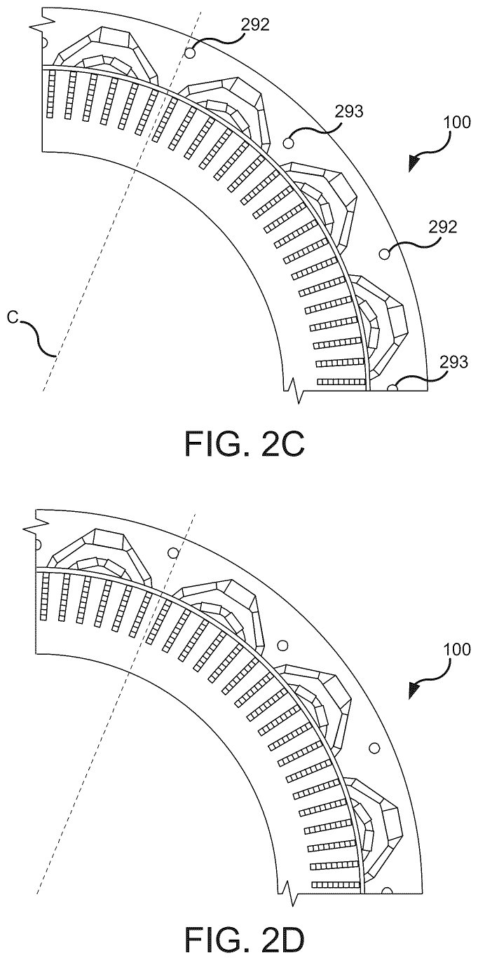

Additional details regarding the electrical conductors of the winding assembly 105, how the winding assembly 105 is installed in the stator assembly 103, and how the combination of the stator assembly 103 and winding assembly 105 causes the rotor assembly 101 to rotate about the stator assembly 103 are discussed below in reference to FIGS. 2A and 2B.

Although the motor 100 in FIG. 1 is shown to have only the rotor assembly 101, the stator assembly, and the winding assembly 105, the motor 100 of FIG. 1 is not limited to just these components and may have other components (e.g., a busbar, wires, connectors, or the like) commonly associated with electrical motors (e.g., in-wheel and/or other types of electrical motors) without departing from the scope of embodiments disclosed herein.

FIG. 2A shows a horizontal cross-sectional view of the motor of FIG. 1 according to an exemplary embodiment of the present disclosure. As shown in FIG. 2A, only a quarter of the full motor 100 is shown.

As further shown in FIG. 2A, the rotor assembly 101 of FIG. 1 includes a rotor body 201 having an outer surface 203 and an inner surface 205. The stator assembly 103 of FIG. 1 similarly includes a stator core 207 having an outer surface 209 and an inner surface 211. The outer surface 203 of the rotor body 201 is further away from the outer surface 209 of the stator core 207 than the inner surface 205 of the rotor body 201. A gap 213 (e.g., the air gap 109 discussed in reference to FIG. 1) is included between the inner surface 205 of the rotor body 201 and the outer surface 209 of the stator core 207.

The rotor body 201 may include one or more magnet pockets 230. Each of the magnet pockets 230 may be an opening formed within the rotor body 201 (e.g., in an axial direction of the rotor body 201) in which one or more magnets (shown below in reference to FIG. 2B) may be inserted.

In embodiments, magnet pockets 241, 243, 245 (also referred to herein as “three first magnet pockets”) may form a first group of magnet pockets 240. As shown in FIG. 2A, the first group of magnet pockets 240 may form a substantially U-shape structure with a bottom (i.e., base) of the U-shape structure formed by magnet pocket 243 being flat and being closer to the outer surface than the two legs of the U-shape structure formed by magnet pockets 241 and 245.

In embodiments, magnet pockets 251 and 253 (also referred to herein as “two second magnet pockets”) may form a second group of magnet pockets 250. As shown in FIG. 2A, the second group of magnet pockets 250 may form a substantially V-shape structure with a tip of the V-shape structure pointing towards the outer surface 203 of the rotor body 201 and the end of the legs of the V-shape structure being close to the inner surface 205 of the rotor body 201.

As also shown in FIG. 2A, the first group of magnet pockets 240 envelops the second group of magnet pockets 250. More specifically, the V-shape structure formed by the two second magnet pockets 251 and 253 is positioned inside of the U-shape structure formed by the three first magnet pockets 241, 243, 245.

In the context of embodiments disclosed herein, a substantially U-shape structure and a substantially V-shape structure may refer to the shape formed by these magnet pockets 251, 253 after magnets are inserted therein (e.g., in a magnet-inserted state of these magnet pockets 251, 253 as shown below in reference to FIG. 2B). In particular, FIG. 2A shows these magnet pockets 251, 253 in a relaxed, non-magnet-inserted state. Due to the nature of the material that forms parts of the rotor body 201 (e.g., elastic plastic materials, polymers, or the like), the relaxed, non-magnet-inserted state of these magnet pockets 251, 253 may look different from the magnet-inserted state.

For example, one having ordinary skill in the art would appreciate that the second group of magnet pockets 250 may have more of an arc-shape structure rather than a V-shape structure in the non-magnet-inserted state. However, as long as a structure that could be interpreted as being V-shaped or close to V-shaped is formed in the magnet-inserted state, the second group of magnet pockets 250 may still form the substantially V-shape structure without departing from the scope of embodiments disclosed herein.

Additionally, although the magnet pockets 241, 243, 245 (and magnet pockets 251 and 253) are shown in the figures as being connected to one another (i.e., formed as a single pocket), each of these magnet pockets 241, 243, 245 may be separate magnet pockets with no connection to another one of the magnet pockets 241, 243, 245. Similarly, magnet pockets 251, 253 may also be individual and non-interconnected magnet pockets.

In embodiments, as further shown in FIG. 2A, the rotor body 201 may be split into several poles (i.e., magnetic poles) 290. Each pole 290 of the rotor body may include one set of the first group of magnet pockets 240 and one set of second group of magnet pockets 250 (i.e., one set of the three first magnet pockets and one set of the two second magnet pockets).

As discussed in more detail below, one or more of the magnets placed into the magnet pockets 241, 243, 245, 251, 253 may be excited using an electromagnetic flux generated by the winding assembly 105 of the stator assembly 103 to cause the rotor body 201 to rotate about the outer surface 209 of the stator core 207.

As also shown in FIG. 2A, the stator core 207 may include stator slots 280 in which the electrical conductors forming the winding assembly 105 of FIG. 1 may be inserted. In particular, each of the stator slots 280 may be designed and dimensioned to receive one or more of the electrical conductors. For example, the electrical conductors of the winding assembly 105 may extend in an axial direction through one or more of the stator slots 280. Alternatively, the electrical conductors of the winding assembly 105 may be disposed about (e.g., wound or slid about) one or more teeth (not shown) of the stator core 207.

Each of the stator slots 280 may have partially open slots such that small openings to the stator slots 280 are provided along the inner surface 211 of the stator core 207. Alternatively, the stator slots 280 may be closed slots. The winding assembly 105 formed by the electrical conductors may carry an excitation current. Current flowing through the electrical conductors generates a stator electromagnetic flux. The stator electromagnetic flux may excite one or more of the magnets to cause the rotor body 201 to rotate about the outer surface 209 of the stator core 207. The stator electromagnetic flux may be controlled by adjusting the magnitude and frequency of the current flowing through the electrical conductors.

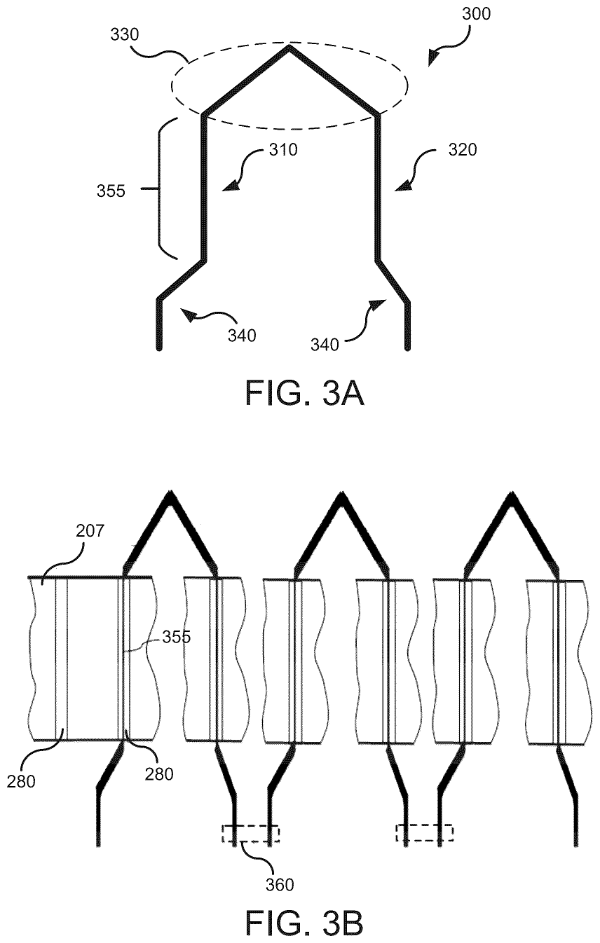

The electrical conductors of the winding assembly 105 may comprise a plurality of winding segments 300. The winding segments 300 may be bent into U-shapes, V-shapes, or any bent shape. These types of conductors are typically referred to a “hairpin” by those skilled in art because of their shapes and will be referred to as such in this description. The example of the hairpin-type winding segment 300 is illustrated and discussed in more detail below in reference to FIG. 3A.

Turning first to FIG. 2B, FIG. 2B shows the same horizontal cross-sectional view of the motor of FIG. 1 according to an exemplary embodiment of the present disclosure. In the exemplary embodiment of FIG. 2B, magnets 281, 283, 285, 287, 289 are inserted into (e.g., occupy) the magnet pockets 230 inside the rotor body 201. In embodiment, magnets 281 and 285 may form a first set of magnets (“Set-1”), magnets 287 and 289 may form a second set of magnets (“Set-2”), and magnet 283 may form a third set of magnets (“Set-3”). In embodiments, an angle between the two legs of a V-shape formed by the Set-1 magnets may be any angle between 0 to 180 degrees (i.e., greater than 0 and less than 180) without departing from the scope of embodiments disclosed herein. Similarly, an angle between the two legs of a V-shape formed by the Set-3 magnets may be any angle between 0 to 180 degrees without departing from the scope of embodiments disclosed herein.

Each of the magnets 281, 283, 285, 287, 289 may be permanent magnets. Any type of permanent magnets that can be used in electrical motors may be used as the magnets 281, 283, 285, 287, 289 without departing from the scope of embodiments disclosed herein.

In embodiments, not all of the magnet pockets 241, 243, 245, 251, 253 have to be filled with magnets 281, 283, 285, 287, 289 as shown in FIG. 2B. More specifically, some of the magnet pockets 241, 243, 245, 251, 253 may be left empty.

In particular, different combinations of the magnet sets (i.e., the first set of magnets, the second set of magnets, and the third set of magnets) may allow the motor 100 of FIG. 1 to provide different output torque (i.e., to provide a variable torque output). More specifically, magnet pockets 241, 243, 245, 251, 253 may be populated or left open depending on a torque requirement of the motor 100. By using different combinations of the magnet sets, the motor output torque of motor 100 can be varied (e.g., affected) to meet different vehicle performance needs (i.e., to meet the torque requirements of the different vehicle drive modes). The various combinations of the magnet sets for different types (e.g., base or premium of vehicles) and the different vehicle drive modes is shown below in Table 1. Other combinations not shown below in Table 1 may also be utilized based on a motor's torque output requirements without departing from the scope of embodiments disclosed herein.

TABLE 1
Example Magnet Set Combinations

| | Magnet | Torque/ | Torque/ | |
|---|---|---|---|---|
| | Volume/Wheel | Wheel | Vehicle | Magnet Set |
| Vehicle | per unit (p.u.) | (p.u.) | (p.u.) | Combination |
| Base | 1 | 1 | 2 | Set-1 + |
| (FWD/RWD) | | | | Set-2 |
| Premium | 1.54 | 1.14 | 2.28 | Set-1 + |
| (FWD/RWD) | | | | Set-2 + |
| | | | | Set-3 |
| AWD -1 | 0.66 | 0.82 | 3.26 | Set-1 |
| AWD -2 | 0.34 | 0.6 | 2.4 | Set-2 |

Thus, such different combinations of the magnet sets allows an existing design (e.g., of the stator, the inverter design, or the like) of an in-wheel (or other type of) motor to advantageously be kept the same while allowing the in-wheel motor to provide the variable torque output. This not only simplifies the design changes when variable torque output is required but also significantly reduces the costs of each motor by avoiding the need to completely change an existing design of the motor through, for example, growing a size or length of the motor in an axial direction of the motor.

Turning now to FIG. 2C, FIG. 2C shows the same horizontal cross-sectional view of the motor of FIG. 1 according to an exemplary embodiment of the present disclosure. In the exemplary embodiment shown in FIG. 2C, the rotor body 201 further includes one or more skew holes 292 and one or more overmold holes 293.

In particular, in an in-wheel application, magnet topology of a motor 100 in an outer rotor topology (e.g., as shown above in reference to FIGS. 2A to 2B) and the rotor (i.e., rotor assembly 101) may sit on a wheel hub of a road wheel of a vehicle. Rotor step skew is a technique that for canceling torque ripple and cogging torque in the motor 100. In an outer rotor topology motor, achieving rotor step skew is more difficult since the steps of the rotor step skew are not pressed into the rotor shaft (namely because no rotor shaft exists).

As a result, during lamination of the motor 100 (namely, during lamination of the rotor body 201 of the rotor assembly 101), one or more skew holes 292 are added to achieve the skew angle required for providing rotor step skew for the motor 100.

As shown in FIG. 2C, in a first step of a two-step skew rotor step skew configuration, skew holes 292 are shifted by: θ_{skew}/2 from a centerline C of the motor 100. Said another one, in a lamination stack of the first step of the two-step skew, the skew holes 292 are kept at θ_{skew}/2 from the centerline C.

In embodiments, a lamination stack during a second step of the two-step skew is flipped in comparison with the lamination stack during the first step of a two-step skew. In particular, in the second step of the two-step skew, as shown in FIG. 2D, the rotor body 201 is rotated by θ_{skew}/2 to align the one or more skew holes 292 and then the lamination stack of the first step and the lamination stack of the second step are stacked together to achieve a correct skew angle by aligning the skew holes 292 of the two stacks/steps.

Additionally, using the two-step skew technique causes a common portion of the magnet pockets 230 to become smaller, making it difficult to overmold and/or flow plastic (or other similar overmolding/molding material) all the way through the length of the rotor body 201 (namely, through the magnet pockets 241, 243, 245, 251, 253) in order to hold the magnets 281, 283, 285, 287, 289 in place in the magnet pockets 241, 243, 245, 251, 253.

As a result, in embodiments, one or more overmold holes 293 are provided in the rotor body 201 for the overmolding and/or plastic flowing (or other similar overmolding/molding material) process to better fill up the magnet pockets XYZ in order to achieve a stronger hold the magnets 281, 283, 285, 287, 289 within the magnet pockets 241, 243, 245, 251, 253.

As shown in FIGS. 2C and 2D, the placement of the one or more skew holes 292 and the one or more overmold holes 293 may be staggered such that one pole of the rotor body 201 may only include one of either the skew hole 292 or the overmold hole 293. Said another way, only of either the skew hole 292 or the overmold hole 293 is placed between each of the first group of magnet pockets 240.

Furthermore, to allow the magnet pockets 241, 243, 245, 251, 253 to be filled up (e.g., backfilled) during the overmolding and/or plastic flowing (or other similar overmolding/molding material) process, one or more of the overmold holes 293 may be connected to at least one of the first and/or second groups of magnet pockets. Additionally, the skew holes 292 may be positioned closer to the outer surface 203 of the rotor body 201 body than the overmold holes 293.

Although a specific arrangement and configuration of the skew and overmold holes are discussed and shown above in FIGS. 2C and 2D, one having ordinary skill in the art would appreciate that other arrangements and configurations (e.g., the number of skew and/or overmold holes between each of the first group of magnet pockets 240, a distance from each of the of the first group of magnet pockets 240 at which the skew and/or overmold holes are placed, etc.) of the skew and overmold holes may be used without departing from the scope of embodiments disclosed herein. In embodiments, the distance from each of the first group of magnet pockets 240 at which the skew and/or overmold holes are placed may be any distance between 0.5 mm to 8 mm radius.

Turning now to FIGS. 3A-3B, FIG. 3A shows a conceptual view of schematically illustrating a hairpin winding segment according to an embodiment of the present disclosure.

As shown in FIG. 3A, the hairpin winding segment 300 includes a first leg 310, a second leg 320, and an endturn portion (or a crown) 330 between the first and second legs 310, 320. The endturn portion 330 can have a substantially U-shaped, V-shaped, or curved-shaped configuration, although, in some embodiments, the endturn portion 330 can have a wave shape, a regular or irregular polygonal shape, and other shapes.

The first and second legs 310, 320 may be substantially parallel to each other. The hairpin winding segment 300 is formed of electrically conductive material, and is configured to allow a current to flow from the first leg 310 to the second leg 320, or vice versa. The hairpin winding segment 300 is electrically isolated from a stator core (e.g., 207, FIGS. 2A-2D) to prevent phase to ground shorts and electrically isolated from one another to prevent phase to phase shorts from occurring. The hairpin winding segments 300 may be arranged in groups of hairpin winding assemblies (e.g., the winding assembly 105 of FIG. 1) that are inserted into select stator slots (e.g., 250, FIGS. 2A-2D) of the stator core. The hairpin winding segments 300 are installed in the stator core by inserting the legs 310, 320 through corresponding ones of the stator slots.

FIG. 3B shows a conceptual view of schematically illustrating the hairpin winding segment of FIG. 3A being inserted into a stator core according to an embodiment of the present disclosure.

As shown in FIG. 3B, each of the first and second legs 310, 320 has an in-slot portion 355 that is inserted into, and, disposed in one of stator slots 280 (see e.g., FIG. 2A) of the stator core 207. Each stator slot 280 is sized to receive one or more in-slot portions 355 of the first and second legs 310, 320 of the hairpin winding segments 300. The first leg 310 is inserted into one of stator slots 280, and the second leg 320 is inserted into another of stator slots 280 (in a same or different row than the stator slow in which the first leg 310 is inserted).

As illustrated in FIG. 3B, all of the hairpin winding segments 300 may be installed from the same end of the stator core 207 so that all endturn portions (or crowns) 330 of the hairpin winding segments 300 are located on one end of the stator core 207 and all open end portion 340 of the hairpin winding segment 300 are located on the other end of the stator core 207.

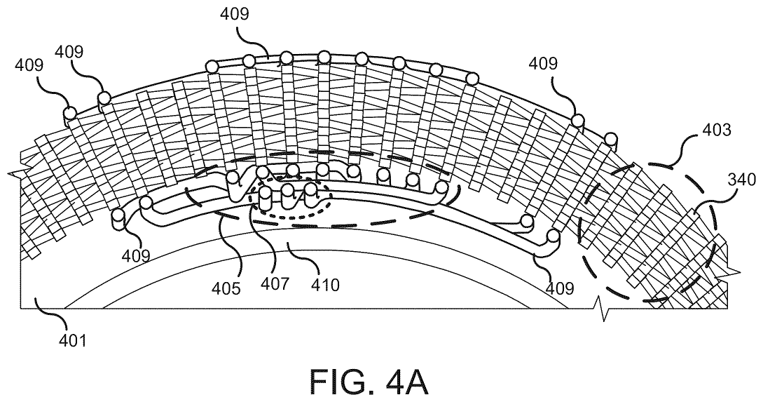

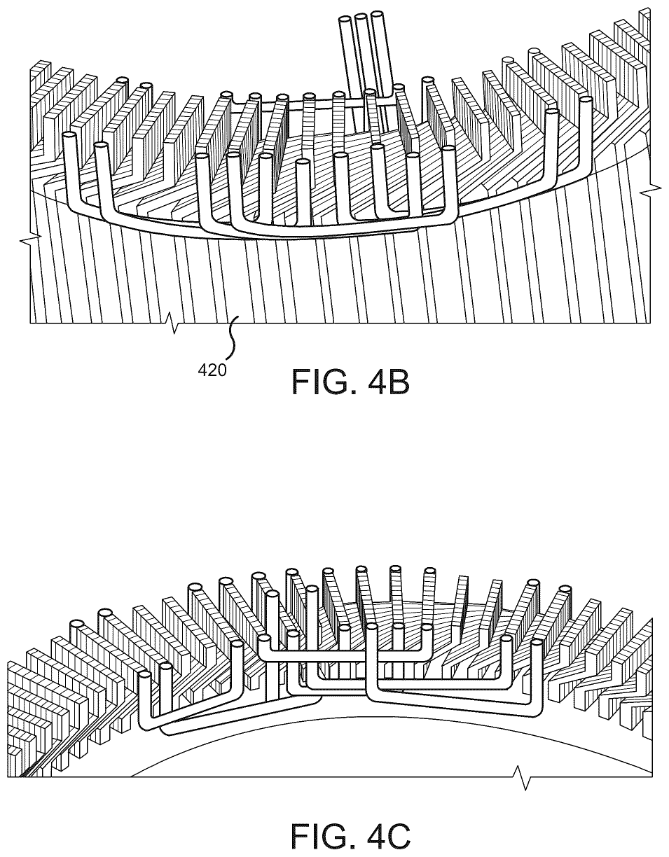

As further shown in FIG. 3B, two open end portions 340 of one hairpin winding segment 300 are bent away from each other to connect with other hairpin winding segments 300. One open end portion 340 of one hairpin winding segment 300 is coupled to another open end portion 340 of another hairpin winding segment 300. For example, the open end portions 340 of corresponding hairpin winding segments 300 are joined or connected by a connection 360 such as a weld, a jumper connection (for instance, 409 of FIGS. 4A-4C), a connection line or any type of connections, or form twists that connect with the twists of other hairpin winding segments 300. Each path includes associated hairpin winding segments 300 that are connected at the open end portions 340 to form a continuous conductor between a terminal (e.g. a terminal connected to an inverter) and a neutral point or connection.

The endturn portion 330 formed between the first and second legs 310, 320 of the hairpin winding segment 300 or the open end portions 340 of the first and second legs 310, 320 of the hairpin winding segment 300 may be exposed to an outside of the stator core 207, and the in-slot portion 355 of the first and second legs 310, 320 of the hairpin winding segment 300 may be disposed inside one of the stator slots 280 of the stator core 207.

Turning now to FIGS. 4A-4C, FIGS. 4A-4C show various perspective views (e.g., a top perspective view, an inside perspective view, an outside perspective view, respectively) of a stator assembly 401 according to an embodiment of the present disclosure. All of the reference characters shown in FIG. 4A are applicable to FIGS. 4B-4C.

As shown in FIGS. 4A-4C, the stator assembly 400 may have a winding assembly 403 (also referred to herein as a “winding arrangement”)). The stator assembly 401 may be the same as the stator assembly 103 discussed above in reference to FIGS. 1-3B. The winding assembly 403 may be the same as winding assembly 105 discussed above in reference to FIGS. 1-3B and include one or more winding segments (e.g., the hairpin winding segment 300 of FIG. 3A).

In addition to the winding assembly 403, the stator assembly 401 may also have a busbar 405. The busbar 405 may have one or more jumpers (and/or cables, traces, or the like) 409 that electrically connect one or more of the winding segments (also referred to herein simply as “windings”) to one another. The busbar 405 may also electrically connect the winding assembly 403 to other electrical components of an electric vehicle such that current is able to be supplied to the winding assembly (e.g., through the busbar 405) to the winding assembly 403 to generate the electromagnetic flux.

As shown in FIGS. 4A-4C, the exposed portion of the winding assembly 403 (made up of namely the open end portion 340 of the winding segments) contributes to a height of the motor (e.g., 100, FIG. 1). As further shown in FIGS. 4A-4C, rather than being installed on a top surface of the winding assembly 403, the busbar 405 (and its corresponding components) is instead installed on the side surfaces of the winding assembly 403. This advantageously prevents the busbar 405 from contributing any additional height to the already existing height of the motor.

In FIGS. 4A-4C, a main body of the busbar 405 (e.g., a busbar body 407 shown as the collection of three jumper cables, which in other embodiments may be implemented using a plate, a connector, or the like) is disposed on a first side of the exposed portion of the winding assembly 403 that is closer toward an inner surface 410 (e.g., 209, FIGS. 2A-2D) of the stator assembly 401 while one or more jumpers 409 of the busbar are disposed on a second side of the exposed portion of the winding assembly 403 that is closer toward an outer surface 420 (e.g., 207, FIGS. 2A-2Df) of the stator assembly. Such a configuration/arrangement may be flipped without departing from the scope of embodiments disclosed herein. As a result, the busbar 405 may be installed on the winding assembly 403 without any part of the busbar body 407 and/or the jumpers 409 covering a tip of the open end portions 340 of each of the winding segments making up the winding assembly 403.

The busbar body 407 of the busbar 405 may receive one or more ends of the jumpers 409 that connect the winding segments of the winding assembly 403. The jumpers 409 of the busbar 405 may have a thickness that is identical (or substantially identical) to a thickness of each of the winding segments making up the winding assembly 403. Alternatively, to advantageously reduce motor resistance, the thickness of the jumpers 409 of the busbar 405.

Although certain portions of the busbar 405 are shown to extend over a top-most surface of the winding assembly 403 in FIGS. 4A-4C, this is done so for illustrative purposes only and an actual stator assembly 401 having the busbar 405 would not have any portion of the busbar 405 extending past the top-most surface of the winding assembly 403 to prevent the busbar 405 from adding more height to the existing height of the stator assembly 401.

Additionally, although specific installation configurations and arrangements of the busbar 405 are shown in FIGS. 4A-4C, one having ordinary skill in the art would appreciate that other configurations and arrangements may be used without departing from the scope of embodiments disclosed herein as along as no parts of the busbar 405 are installed directly on top of the top-most surface of the winding assembly 403.

Further, in embodiments, the busbar 405 and connections (e.g., jumpers 406) may be placed away from an airgap (e.g., gap 109 of FIG. 1) between the rotor assembly 101 and the stator assembly 103. For example, one connection of the connections may be placed close to the airgap while another connection of the connections may be placed away from the airgap. Alternatively, all connections may be placed away from the airgap.

The motor 100 according to certain exemplary embodiments of the present disclosure may be employed in a vehicle 800. The vehicle 800 may be any passenger or commercial automobile such as a hybrid vehicle, an electric vehicle, or any other type vehicles. FIG. 5 is a schematic view of a vehicle including a steering system and a brake assembly according to an exemplary embodiment of the present disclosure. The vehicle 800 may include a steering system 810 for use in a vehicle. The steering system 810 can allow a driver or operator of the vehicle 800 to control the direction of the vehicle 800 or road wheels 830 of the vehicle 800 through the manipulation of a steering wheel 820. The steering wheel 820 is operatively coupled to a steering shaft (or steering column) 822. The steering wheel 820 may be directly or indirectly connected with the steering shaft 822. For example, the steering wheel 820 may be connected to the steering shaft 822 through a gear, a shaft, a belt and/or any connection means. The steering shaft 822 may be installed in a housing 824 such that the steering shaft 822 is rotatable within the housing 824.

The road wheels 830 may be connected to knuckles, which are in turn connected to tie rods. The tie rods are connected to a steering assembly 832. The steering assembly 832 may include a steering actuator motor 834 (e.g., the motor 100 described above) and steering rods 836. The steering rods 836 may be operatively coupled to the steering actuator motor 834 such that the steering actuator motor 834 is adapted to move the steering rods 836. The movement of the steering rods 836 controls the direction of the road wheels 830 through the knuckles and tie rods.

One or more sensors 840 may be configured to detect position, angular displacement or travel 825 of the steering shaft 822 or steering wheel 820, as well as detecting the torque of the angular displacement. The sensors 840 provide electric signals to a controller 850 indicative of the angular displacement and torque 825. The controller 850 sends and/or receives signals to/from the steering actuator motor 834 to actuate the steering actuator motor 834 in response to the angular displacement 825 of the steering wheel 820.

In the steer-by-wire steering system, the steering wheel 820 may be mechanically isolated from the road wheels 830. For example, the steer-by-wire system has no mechanical link connecting the steering wheel 825 from the road wheels 830. Accordingly, the steer-by wire steering system may comprise a feedback actuator or steering feel actuator 828 comprising an electric motor (e.g., the motor 100 described above) which is connected to the steering shaft or steering column 822. The feedback actuator or steering feel actuator 828 provides the driver or operator with the same “road feel” that the driver receives with a direct mechanical link.

Although the embodiment illustrated in FIG. 5 shows the vehicle having the steer-by-wire steering system, the motor 100 according to exemplary embodiments of the present disclosure can be used in a vehicle having a mechanical steering system. The mechanical steering system typically includes a mechanical linkage or a mechanical connection between the steering wheel 820 and the road wheels 830. In the mechanical steering system, the steering actuator motor 834 includes an electric motor (e.g., the motor 100 described above) to provide power to assist the movement of the road wheels 830 in response to the operation of the driver or a control signal of the controller 850.

Accordingly, the motor 100 according to some embodiment of the present disclosure can be used as the steering actuator motor 834 or can be included in the feedback actuator or steering feel actuator 828.

The motor 100 can be employed in an electromagnetic brake assembly 860. The electromagnetic brake assembly 860 is configured to cause the road wheel 830 to slow or stop motion using electromagnetic force to apply mechanical resistance or friction by using the torque generated by the motor 100.

Although the example embodiments have been described in detail, it should be understood that various changes, substitutions and alterations can be made herein without departing from the spirit and scope of the application as defined by the appended claims.

Moreover, the scope of the present application is not intended to be limited to the particular embodiments of the process, machine, manufacture, and composition of matter, means, methods and steps described in the specification. As one of ordinary skill in the art will readily appreciate from the disclosure, processes, machines, manufacture, compositions of matter, means, methods or steps, presently existing or later to be developed, that perform substantially the same function or achieve substantially the same result as the corresponding embodiments described herein may be utilized according to the embodiments and alternative embodiments. Accordingly, the appended claims are intended to include within their scope such processes, machines, manufacture, compositions of matter, means, methods, or steps.

What is claimed is:

1. A motor comprising:
a stator assembly; and
a rotor assembly configured to be rotatable relative to the stator assembly,
wherein the rotor assembly comprises a rotor body that comprises:
a first group of magnet pockets comprising three first magnet pockets; and
a second group of magnet pockets comprising two second magnet pockets, the second group of magnet pockets being positioned closer toward an inner surface of the rotor body than the first group of magnet pockets.

2. The motor of claim 1, wherein the rotor assembly surrounds the stator assembly.

3. The motor of claim 1, wherein the rotor assembly further comprises a skew hole and an overmold hole.

4. The motor of claim 1, wherein the three first magnet pockets form a U-shape structure with a bottom of the U-shape structure being flat and made up of one of the three first magnet pockets and two legs of the U-shape structure being respectively made up of a remaining two of the three first magnet pockets.

5. The motor of claim 4, wherein
the two second magnet pockets form a V-shape structure,
and the two second magnets are positioned within the U-shape structure formed by the three first magnet pockets.

6. The motor of claim 5, wherein a single pole of the rotor body comprises one set of the three first magnet pockets and one set of the two second magnet pockets.

7. The motor of claim 5, wherein the rotor assembly further comprises magnets installed within at least one of the first group of magnet pockets or the second group of magnet pockets in one or more magnet combinations, each of the one or more magnet combinations affecting a torque output of the motor.

8. The motor of claim 7, wherein
the one or more magnet combinations comprises combinations made up of a first set of magnets, a second set of magnets, and a third set of magnets,
the first set of magnets occupying the two legs of the U-shape structure formed by the three first magnet pockets,
the second set of magnets occupying the two second magnet pockets forming the V-shape structure, and
the third set of magnets occupying the one of the three first magnet pockets making up the bottom of the U-shape structure.

9. The motor of claim 3, wherein the overmold hole is connected to at least one of the first and/or second groups of magnet pockets.

10. The motor of claim 9, wherein the overmold hole is a hole in which molding material flows for backfilling at least one of the three first magnet pockets or at least one of the two second magnet pockets during a molding process of the rotor assembly.

11. The motor of claim 3, wherein the skew hole is positioned closer to an outer surface of the rotor body than the overmold hole, the outer surface of the rotor body being further away from the stator assembly than the inner surface of the rotor body.

12. The motor of claim 11, wherein
the motor comprises a plurality of the first group of magnet pockets,
the skew hole is positioned between at least two of the plurality of the first group of magnet pockets and shifted by θ_{skew}/2 from a centerline of the motor, and
an area between at least two of the plurality of the first group of magnet comprises only one of either the skew hole or the overmold hole.

13. The motor of claim 1, wherein the motor is an in-wheel motor for an electric vehicle.

14. A vehicle comprising:
one or more road wheels configured to cause the vehicle to move;
a steering wheel configured to generate an input for controlling the one or more road wheels;
a brake assembly configured to operate a vehicle brake associated with the one or more road wheels; and
one or more motors operatively connected to one or more of the one or more road wheels, the steering wheel, and the brake assembly, at least one of the motors comprising:
a stator assembly; and
a rotor assembly configured to be rotatable relative to the stator assembly,
wherein the rotor assembly comprises a rotor body that comprises:
a first group of magnet pockets comprising three first magnet pockets; and
a second group of magnet pockets comprising two second magnet pockets, the second group of magnet pockets being positioned closer toward an inner surface of the rotor body than the first group of magnet pockets.

15. The vehicle of claim 14, wherein the rotor assembly surrounds the stator assembly.

16. The vehicle of claim 14, wherein the rotor assembly further comprises a skew hole and an overmold hole.

17. The vehicle of claim 14, wherein the three first magnet pockets form a U-shape with a bottom of the U-shape being flat and made up of one of the three first magnet pockets and two legs of the U-shape being respectively made up of a remaining two of the three first magnet pockets.

18. The vehicle of claim 17, wherein
the two second magnet pockets form a V-shape,
and the two second magnets are position within the U-shape formed by the three first magnet pockets.

19. The vehicle of claim 18, wherein a single pole of the rotor comprises one set of the three first magnet pockets and one set of the two second magnet pockets.

20. The vehicle of claim 18, wherein the rotor assembly further comprises magnets installed within at least one of the first group of magnet pockets or the second group of magnet pockets in one or more magnet combinations, each of the one or more magnet combinations affecting a torque output of the motor.
